(19) United States
(12) Patent Application Publication
(10) Pub. No.: US 2019/0035522 A1
(43) Pub. Date: Jan. 31, 2019

(54) MAGNETIC POWDER AND METHOD FOR MANUFACTURING THE SAME, AND MAGNETIC RECORDING MEDIUM AND METHOD FOR MANUFACTURING THE SAME

(71) Applicant: SONY CORPORATION, TOKYO (JP)

(72) Inventor: KENJI KATORI, KANAGAWA (JP)

(21) Appl. No.: 16/073,304

(22) PCT Filed: Feb. 7, 2017
(86) PCT No.: PCT/JP2017/004418

§ 371 Date: Jul. 26, 2018

(30) Foreign Application Priority Data
Feb. 10, 2016 (JP) 2016-023871

(51) Int. Cl. H01F 1/11; H01F 41/14; G11B 5/65

(52) U.S. Cl. CPC H01F 1/11; G11B 5/656; H01F 41/14

(57) ABSTRACT

A method for manufacturing a magnetic powder includes changing a coercive force of a magnetic powder by irradiation with a radiation.

### TECHNICAL FIELD

The present technology relates to a magnetic powder and a method for manufacturing the same, and a magnetic recording medium and a method for manufacturing the same.

### BACKGROUND ART

A magnetic recording medium desirably has a high coercive force Hc from a viewpoint of recording density. Meanwhile, a magnetic field that can be generated at the time of writing is limited, and therefore the coercive force Hc of the recording medium is desirably adjusted to a predetermined value or less according to ability of a magnetic writing head from a viewpoint of the magnetic writing head. Therefore, a magnetic powder having a predetermined coercive force Hc and a method for manufacturing the same have been studied.

In recent years, a cobalt ferrite magnetic powder is expected as a magnetic powder for an application type high density recording medium. As a method for manufacturing a cobalt ferrite magnetic powder having a predetermined coercive force, a method for introducing an additive to a magnetic powder and a method for introducing lattice defects into a magnetic powder by mechanical milling have been proposed (see, for example, Patent Document 1).

### CITATION LIST

### Non-Patent Document

Non-Patent Document 1: Ponce A. S. et al. “High coercivity induced by mechanical milling in cobalt Ferrite powders” Journal of Magnetism and Magnetic Materials Volume 344, October 2013, Pages 182-187

### SUMMARY OF THE INVENTION

### Problems to be Solved by the Invention

However, with a magnetic powder obtained by the above-proposed manufacturing method, a variation in coercive force Hc may be large.

An object of the present technology is to provide a magnetic powder having a predetermined coercive force Hc and a small variation in coercive force Hc and a method for manufacturing the same, and a magnetic recording medium and a method for manufacturing the same.

### Solutions to Problems

In order to solve the above problems, a first technique is a method for manufacturing a magnetic powder, including changing a coercive force of a magnetic powder by irradiation with a radiation.

A second technique is a method for manufacturing a magnetic recording medium, including changing a coercive force of a magnetic powder by irradiation with a radiation and forming a magnetic layer containing the magnetic powder having the coercive force changed.

A third technique is a magnetic powder having lattice defects, including magnetic particles containing cubic ferrite, having a coercive force of 2500 Oe or more and 4000 Oe or less, and having a switching field distribution of 1 or less.

A fourth technique is a magnetic recording medium including a substrate and a magnetic layer containing a magnetic powder, in which the magnetic powder has lattice defects, includes magnetic particles containing cubic ferrite, has a coercive force of 2500 Oe or more and 4000 Oe or less, and has a switching field distribution of 1 or less.

### Effects Of The Invention

As described above, according to the present technology, a magnetic powder having a predetermined coercive force Hc and a small variation in coercive force Hc can be obtained.

### BRIEF DESCRIPTION OF DRAWINGS

FIG. 1 is a cross sectional view illustrating one configuration example of a magnetic recording medium according to a third embodiment of the present technology.

### MODE FOR CARRYING OUT THE INVENTION

In the present technology, lattice defects are introduced into a magnetic powder by irradiation with a radiation, and a coercive force Hc of the magnetic powder is changed. This change in coercive force Hc varies depending on the type of magnetic powder. Some types of magnetic powders increase the coercive force Hc, and some types of magnetic powders decrease the coercive force Hc by irradiation with a radiation (that is, introduction of lattice defects). For example, in a case where the magnetic powder is a cubic ferrite magnetic powder (for example, a cobalt ferrite magnetic powder and the like), when lattice defects are introduced by irradiation with a radiation, the coercive force Hc of the magnetic powder increases. Meanwhile, in a case where the magnetic powder is a hexagonal ferrite magnetic powder (for example, a barium ferrite magnetic powder and the like), when lattice defects are introduced by irradiation with a radiation, the coercive force Hc of the magnetic powder decreases. Incidentally, in a case of a magnetic powder in which a coercive force Hc is generated mainly due to shape anisotropy (for example, an acicular magnetic powder such as a γ-Fe₂O₃ magnetic powder or a metal magnetic powder), when lattice defects are introduced by irradiation with a radiation, it is recognized that magnetization decreases and the coercive force Hc decreases, but a large change in coercive force Hc is not usually generated.

Embodiments of the present technology will be described in the following order.

1 First embodiment (example of cubic ferrite magnetic powder)

1.1 Configuration of magnetic powder

1.2 Method for manufacturing magnetic powder

1.3 Effect

1.4 Modification Example

2 Second embodiment (example of hexagonal ferrite magnetic powder)

2.1 Configuration of magnetic powder

2.2 Method for manufacturing magnetic powder

2.3 Effect

3 Third embodiment (example of magnetic recording medium)

3.1. Configuration of magnetic recording medium

3.2. Method for manufacturing magnetic recording medium

3.3 Effect

3.4 Modification Example

### 1. First Embodiment

### 1.1 Configuration of Magnetic Powder

A magnetic powder according to a first embodiment of the present technology is a cubic ferrite magnetic powder (spinel ferrite magnetic powder) for a magnetic recording medium. The magnetic powder has a coercive force Hc of 2500 Oe or more and 4000 Oe or less, preferably of 2500 Oe or more and 3500 Oe or less. The magnetic powder has a switching field distribution (hereinafter referred to as “SFD”) of 1 or less, preferably of 0.7 or less.

The magnetic powder having the above coercive force Hc and SFD is suitable as a magnetic powder for a high density magnetic recording medium. Specifically, in a case where the magnetic powder having the above coercive force Hc and SFD is applied to a magnetic layer (recording layer) of a high density magnetic recording medium, the following advantages are obtained. That is, a coercive force Hc of 2500 Oe or more makes it possible to favorably maintain a recording region of the magnetic layer and to obtain high thermal stability. Meanwhile, a coercive force Hc of 4000 Oe or less makes it possible to favorably record a signal on the magnetic layer. An SFD of 1 or less makes it possible to obtain a high-quality reproduction output. Note that a distribution of a coercive force Hc is generally evaluated by an SFD. When a differential curve near a coercive force Hc is taken in a hysteresis loop of a magnetic recording medium using a magnetic powder, an SFD is represented by a value (AH/Hc) obtained by dividing a half value width AH of a peak of the curve by the coercive force Hc.

The cubic ferrite magnetic powder includes magnetic particles of an iron oxide having a main phase of cubic ferrite (hereinafter referred to as “cubic ferrite magnetic particles”). The cubic ferrite contains, for example, one or more selected from the group consisting of Co, Ni, Mn, Al, Cu, and Zn. The cubic ferrite is preferably cobalt ferrite containing Co. In addition to Co, the cobalt ferrite may further contain one or more selected from the group consisting of Ni, Mn, Al, Cu, and Zn.

More specifically, the cubic ferrite has an average composition represented by a general formula MFe₂O₄. However, M is, for example, one or more metals selected from the group consisting of Co, Ni, Mn, Al, Cu, and Zn. M is preferably Co. M may be a combination of Co and one or more metals selected from the group consisting of Ni, Mn, Al, Cu, and Zn. In the above general formula, a part of Fe may be replaced with another metal element.

The cubic ferrite magnetic particles have lattice defects. The lattice defects are distributed with high uniformity throughout the cubic ferrite magnetic powder. For this reason, a low SFD is obtained as described above. Note that some of the cubic ferrite magnetic particles constituting the cubic ferrite magnetic powder may have lattice defects, or substantially all the cubic ferrite magnetic particles may have lattice defects.

Each of the cubic ferrite magnetic particles has a cubic or substantially cubic shape. An average plate diameter (average particle size) of the cubic ferrite magnetic particles is preferably 14 nm or less, and more preferably 10 nm or more and 14 nm or less.

### 1.2 Method for Manufacturing Magnetic Powder

Hereinafter, a method for manufacturing the magnetic powder having the above configuration will be described. First, a magnetic powder having a predetermined coercive force Hc is prepared. Subsequently, by irradiating the magnetic powder with a radiation, lattice defects are introduced into a crystal lattice of the magnetic powder. As a result, the coercive force Hc of the magnetic powder increases. At the time of irradiation with a radiation, the magnetic powder is preferably cooled so as to have a predetermined temperature or lower (for example, 100° C. or lower). As a result, an intended magnetic powder can be obtained.

As the radiation, one or both of an ionizing radiation and a non-ionizing radiation can be used as long as lattice defects can be introduced into a magnetic powder. However, the ionizing radiation is preferably used from a viewpoint of productivity of a magnetic powder or the like. In a case where both the ionizing radiation and the non-ionizing radiation are used, both the radiations may be emitted simultaneously or sequentially.

As the radiation, one or both of an electromagnetic radiation and a particle radiation can be used. In a case where both the electromagnetic radiation and the particle radiation are used, both the radiations may be emitted simultaneously or sequentially.

As the electromagnetic radiation, for example, one or more selected from the group consisting of a gamma ray (γ ray), an X ray, and an ultraviolet ray can be used. As the particle radiation, for example, one or more selected from the group consisting of an alpha ray (α ray), a beta ray (β ray), an electron ray, a proton ray, a neutron ray, and a heavy particle ray can be used. One or more selected from the group consisting of a γ ray, an α ray, and a β ray are preferably used from viewpoints of productivity of a magnetic powder, suppression of activation of the magnetic powder, and the like. In a case where two or more kinds of the electromagnetic radiation or the particle radiation are used, two or more kinds of radiations may be emitted simultaneously or sequentially. In addition, in a case where both the electromagnetic radiation and the particle radiation are used, both the radiations may be emitted simultaneously or sequentially.

Conditions for irradiation with a radiation are adjusted such that a coercive force Hc of a magnetic powder is within a predetermined range and an SFD of the magnetic powder is within a predetermined range. Here, the predetermined range of the coercive force Hc is 2500 Oe or more and 4000 Oe or less, and preferably 2500 Oe or more and 3500 Oe or less. In addition, the predetermined range of the SFD is 1 or less, and preferably 0.7 or less.

It can be confirmed by the following method (1) or (2) whether a magnetic powder has been obtained by the above method for manufacturing a magnetic powder. In addition, by combining these methods (1) and (2), the confirmation can be performed more reliably.

(1) First, a magnetic powder (hereinafter referred to as a “confirmation sample”) for confirming whether the magnetic powder has been obtained by the above method for manufacturing a magnetic powder is prepared. Subsequently, an SFD of the confirmation sample is measured with a vibrating sample magnetometer (VSM). If the measured SFD is 1 or less, the confirmation sample has been obtained by the above method for manufacturing a magnetic powder.

(2) First, a confirmation sample and a magnetic powder (hereinafter referred to as a “comparison sample”) obtained by a known lattice introduction method such as mechanical milling are prepared. Subsequently, the confirmation sample and the comparison sample are observed with a transmission electron microscope (TEM), and it is confirmed whether lattice defects of the confirmation sample have higher uniformity than lattice defects of the comparison sample. If the confirmation sample has higher uniformity than the comparison sample, the confirmation sample has been obtained by the above method for manufacturing a magnetic powder.

### 1.3. Effect

The magnetic powder according to the first embodiment has a coercive force Hc of 2500 Oe or more and 4000 Oe or less and has an SFD of 1 or less. Therefore, a magnetic powder having a predetermined coercive force Hc and a small variation in coercive force Hc can be obtained. Therefore, a magnetic powder suitable for use in a magnetic layer (recording layer) of a high density magnetic recording medium can be provided.

In the method for manufacturing a magnetic powder according to the first embodiment, lattice defects can be uniformly introduced into a magnetic powder by irradiation with a radiation, and the coercive force Hc of the magnetic powder can be increased. As a result, a magnetic powder having a predetermined coercive force Hc and a small distribution in coercive force Hc can be obtained. Therefore, characteristics of a magnetic powder for a magnetic recording medium can be improved by irradiation with a radiation.

The method for manufacturing a magnetic powder according to the first embodiment has an advantage that lattice defects can be uniformly introduced into a magnetic powder in a short period of time as compared with a method for manufacturing a magnetic powder using mechanical milling.

As a magnetic powder for a high density magnetic recording medium, a magnetic powder having a high coercive force Hc is preferable. However, a general cobalt ferrite magnetic powder has a low coercive force Hc, and therefore an increase in coercive force Hc is required. As described above, in the method for manufacturing a magnetic powder according to the first embodiment, the coercive force Hc of the cobalt ferrite magnetic powder can be increased by irradiation with a radiation to be adjusted to a predetermined coercive force Hc. Therefore, the method for manufacturing a magnetic powder according to the first embodiment can meet the above requirement.

### 1.4 Modification Example

In the first embodiment described above, an example has been described in which the present technology is applied to a magnetic powder suitable for use in a magnetic layer (recording layer) of a magnetic recording medium and a method for manufacturing the same, but the present technology is not limited thereto. That is, the present technology is also applicable to a magnetic powder suitable for use in various members, devices, and the like other than a magnetic recording medium and a method for manufacturing the same. In this case, by appropriately adjusting the absorbed dose of a radiation or the like, it is only required to adjust a coercive force Hc to a value required for a member or a device to which the magnetic powder is applied.

### 2 Second Embodiment

### 2.1 Configuration of Magnetic Powder

A magnetic powder according to a second embodiment of the present technology is a hexagonal ferrite magnetic powder. The magnetic powder has a coercive force Hc of 2500 Oe or more and 4000 Oe or less, preferably of 2500 Oe or more and 3500 Oe or less. The magnetic powder has an SFD of 1 or less, preferably of 0.7 or less. The magnetic powder having the above coercive force Hc and SFD is suitable as a magnetic powder for a high density magnetic recording medium. Specifically, in a case where the magnetic powder having the above coercive force Hc and SFD is applied to a magnetic layer (recording layer) of a high density magnetic recording medium, the following advantages are obtained. That is, a coercive force Hc of 2500 Oe or more makes it possible to favorably maintain a recording region of the magnetic layer and to obtain high thermal stability. Meanwhile, a coercive force Hc of 4000 Oe or less makes it possible to favorably record a signal on the magnetic layer. An SFD of 1 or less makes it possible to obtain a high-quality reproduction output.

The hexagonal ferrite magnetic powder includes magnetic particles of an iron oxide having a main phase of hexagonal ferrite (hereinafter referred to as “hexagonal ferrite magnetic particles”). The hexagonal ferrite contains, for example, one or more selected from the group consisting of Ba, Sr, Pb, and Ca. The hexagonal ferrite is preferably barium ferrite containing Ba. In addition to Ba, the barium ferrite may further contain one or more selected from the group consisting of Sr, Pb, and Ca.

More specifically, the hexagonal ferrite has an average composition represented by a general formula MFe₁₂O₁₉. However, M is, for example, one or more metals selected from the group consisting of Ba, Sr, Pb, and Ca. M is preferably Ba. M may be a combination of Ba and one or more metals selected from the group consisting of Sr, Pb, and Ca. In the above general formula, a part of Fe may be replaced with another metal element.

The hexagonal ferrite magnetic particles have lattice defects. The lattice defects are distributed with high uniformity throughout the hexagonal ferrite magnetic powder. For this reason, a low SFD is obtained as described above. Note that some of the hexagonal ferrite magnetic particles constituting the hexagonal ferrite magnetic powder may have lattice defects, or substantially all the hexagonal ferrite magnetic particles may have lattice defects.

An average particle diameter (average plate diameter) of the hexagonal ferrite magnetic particles is preferably 32 nm or less, and more preferably 15 nm or more and 32 nm or less. An average particle thickness of the hexagonal ferrite magnetic particles is preferably 9 nm or less, and more preferably 7 nm or more and 9 nm or less. An average aspect ratio (average particle diameter/average particle thickness) of the hexagonal ferrite magnetic particles is preferably 3.9 or less, and more preferably 1.9 or more and 3.9 or less.

### 2.2 Method for Manufacturing Magnetic Powder

Hereinafter, a method for manufacturing the magnetic powder having the above configuration will be described. First, a magnetic powder having a predetermined coercive force Hc is prepared. Subsequently, by irradiating the magnetic powder with a radiation, lattice defects are introduced into a crystal lattice of the magnetic powder. As a result, the coercive force Hc of the magnetic powder decreases. As a result, an intended magnetic powder can be obtained.

Conditions for irradiation with a radiation are adjusted such that a coercive force Hc of a magnetic powder is within a predetermined range and an SFD of the magnetic powder is within a predetermined range. Here, the predetermined range of the coercive force Hc is 2500 Oe or more and 4000 Oe or less, and preferably 2500 Oe or more and 3500 Oe or less. In addition, the predetermined range of the SFD is 1 or less, and preferably 0.7 or less.

A method for manufacturing a magnetic powder according to the second embodiment is similar to that according to the first embodiment in points other than the above.

### 2.3 Effect

The magnetic powder according to the second embodiment has a coercive force Hc of 2500 Oe or more and 4000 Oe or less and has an SFD of 1 or less. Therefore, a magnetic powder having a predetermined coercive force Hc and a small variation in coercive force Hc can be obtained. Therefore, a magnetic powder suitable for use in a magnetic layer (recording layer) of a high density magnetic recording medium can be provided.

In the method for manufacturing a magnetic powder according to the second embodiment, lattice defects can be uniformly introduced into a magnetic powder by irradiation with a radiation, and the coercive force Hc of the magnetic powder can be decreased. As a result, a magnetic powder having a predetermined coercive force Hc and a small distribution in coercive force Hc can be obtained. Therefore, characteristics of a magnetic powder for a magnetic recording medium can be improved by irradiation with a radiation.

As a magnetic powder for a high density magnetic recording medium, a magnetic powder having a predetermined coercive force Hc is preferable. However, a general hexagonal ferrite magnetic powder has a too high coercive force Hc, and therefore a decrease in coercive force Hc is required. As described above, in the method for manufacturing a magnetic powder according to the first embodiment, the coercive force Hc of the hexagonal ferrite magnetic powder can be decreased by irradiation with a radiation to be adjusted to a predetermined coercive force Hc. Therefore, the method for manufacturing a magnetic powder according to the first embodiment can meet the above requirement.

### 3 Third Embodiment

### 3.1. Configuration of Magnetic Recording Medium

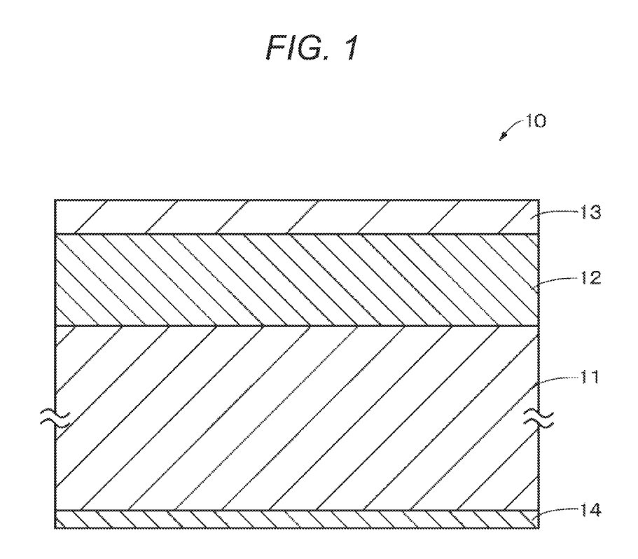

As illustrated in FIG. 1, a magnetic recording medium 10 according to a third embodiment of the present technology includes a substrate 11, a nonmagnetic layer 12 disposed on one main surface of the substrate 11, and a magnetic layer 13 disposed on the nonmagnetic layer 12. The magnetic recording medium 10 may further include a back coat layer 14 disposed on the other main surface of the substrate 11, if necessary. In addition, the magnetic recording medium 10 may further include a protective layer disposed on the magnetic layer 13 and a lubricant layer disposed on the protective layer, if necessary.

### Substrate

The substrate 11 serving as a support is an elongated nonmagnetic substrate having flexibility. The nonmagnetic substrate is a film, and the film has a thickness of 3 μm or more and 8 μm or less, for example. Examples of a material of the substrate 11 include a polyester such as polyethylene terephthalate, a polyolefin such as polyethylene or polypropylene, a cellulose derivative such as cellulose triacetate, cellulose diacetate, or cellulose butyrate, a vinyl-based resin such as polyvinyl chloride or polyvinylidene chloride, a plastic such as polycarbonate, polyimide, or polyamideimide, a light metal such as an aluminum alloy or a titanium alloy, a ceramic such as alumina glass, and the like. In order to enhance a mechanical strength of a magnetic recording medium, a thin film containing an oxide of Al or Cu or the like may be disposed on at least one main surface of the substrate 11.

### Nonmagnetic Layer

The nonmagnetic layer 12 is an underlayer containing a nonmagnetic powder and a binder. The nonmagnetic layer 12 may further contain various additives such as conductive particles, a lubricant, and an abrasive, if necessary.

The nonmagnetic powder may be an inorganic substance or an organic substance. In addition, carbon black and the like can also be used. Examples of the inorganic substance include a metal, a metal oxide, a metal carbonate, a metal sulfate, a metal nitride, a metal carbide, a metal sulfide, and the like. Examples of the shape of the nonmagnetic powder include various shapes such as an acicular shape, a spherical shape, and a plate shape, but are not limited thereto.

As the binder, a resin having a structure obtained by subjecting a polyurethane-based resin, a vinyl chloride-based resin, or the like to a crosslinking reaction is preferable. However, the binder is not limited to these resins, and other resins may be blended appropriately according to physical properties and the like required for a magnetic recording medium. A resin blended is not particularly limited as long as being generally used in an application type magnetic recording medium.

Examples of the resin blended include vinyl chloride, vinyl acetate, a vinyl chloride-vinyl acetate copolymer, a vinyl chloride-vinylidene chloride copolymer, a vinyl chloride-acrylonitrile copolymer, an acrylate-acrylonitrile copolymer, an acrylate-vinyl chloride-vinylidene chloride copolymer, a vinyl chloride-acrylonitrile copolymer, an acrylate-acrylonitrile copolymer, an acrylate-vinylidene chloride copolymer, a methacrylate-vinylidene chloride copolymer, a methacrylate-vinyl chloride copolymer, a methacrylate-ethylene copolymer, polyvinyl fluoride, a vinylidene chloride-alrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, and nitrocellulose), a styrene-butadiene copolymer, a polyester resin, an amino resin, a synthetic rubber, and the like.

Examples of a thermosetting resin or a reactive resin include a phenol resin, an epoxy resin, a urea resin, a melamine resin, an alkyd resin, a silicone resin, a polyamine resin, and a urea formaldehyde resin.

In order to improve dispersibility of a magnetic powder, a polar functional group such as —SO₃M, —OSO₃M, —COOM, or P═O(OM)₂ may be introduced into each of the above binders. Herein, in the formulae, M represents a hydrogen atom or an alkali metal such as lithium, potassium, or sodium.

Examples of the polar functional group include a side chain type group having a terminal group of —NR1R2 or —NR1R2R3+X—, and a main chain type group of >NR1R2+X-. Herein, in the formulae, R1, R2, and R3 each represent a hydrogen atom or a hydrocarbon group, and X- represents an ion of a halogen element such as fluorine, chlorine, bromine, or iodine, or an inorganic or organic ion. In addition, examples of the polar functional group include —OH, —SH, —CN, and an epoxy group.

As the conductive particles, fine particles mainly containing carbon, for example, carbon black can be used. Examples of the carbon black include Asahi #15 and #15HS manufactured by Asahi Carbon Co., Ltd, and the like. In addition, hybrid carbon in which carbon is attached to surfaces of silica particles may be used.

As the lubricant, for example, an ester of a monobasic fatty acid having 10 to 24 carbon atoms and any one of monohydric to hexahydric alcohols each having 2 to 12 carbon atoms, a mixed ester thereof, and a di- or tri-fatty acid ester can be used appropriately. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, and octyl myristate.

As the abrasive, for example, α-alumina having an α conversion ratio of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular a iron oxide obtained by dehydrating and annealing a raw material of magnetic iron oxide, a product obtained by surface treatment thereof with aluminum and/or silica if necessary, and the like are used singly or in combination thereof.

Magnetic layer

The magnetic layer 13 is, for example, a perpendicular recording layer capable of short wavelength recording or ultra short wavelength super recording. The magnetic layer 13 has an average thickness preferably of 30 nm or more and 100 nm or less, more preferably of 50 nm or more and 70 nm or less.

The magnetic layer 13 is, for example, a magnetic layer containing magnetic powder and a binder. The magnetic layer 13 may further contain various additives such as conductive particles, a lubricant, and an abrasive, if necessary.

The magnetic powder is the above magnetic powder (cubic ferrite magnetic powder) according to the first embodiment. This magnetic powder is oriented in a thickness direction or a longitudinal direction of the elongated substrate 11.

The binder, the conductive particles, the lubricant, and the abrasive are similar to those of the nonmagnetic layer 12 described above.

As nonmagnetic reinforcing particles, the magnetic layer 13 may further contain aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), and the like.

### Back Coat Layer

The back coat layer 14 contains a binder, inorganic particles, and a lubricant. The back coat layer 14 may contain various additives such as a curing agent and an antistatic agent, if necessary. The binder, the inorganic particles, and the lubricant are similar to those of the nonmagnetic layer 12 described above.

### 3.2. Method for Manufacturing Magnetic Recording Medium

Hereinafter, a method for manufacturing a magnetic recording medium according to the third embodiment of the present technology will be exemplified.

### Step of Adjusting Coating Material

First, a nonmagnetic powder, a binder, and the like are kneaded and dispersed in a solvent to prepare a nonmagnetic layer-forming coating material. Subsequently, a magnetic powder, a binder, and the like are kneaded and dispersed in a solvent to prepare a magnetic layer-forming coating material. As the magnetic powder, one obtained by the above method for manufacturing a magnetic powder according to the first embodiment is used. Subsequently, a binder, inorganic particles, a lubricant, and the like are kneaded and dispersed in a solvent, if necessary, to prepare a back coat layer-forming coating material. For example, the following solvents, dispersing apparatuses, and kneading apparatuses can be applied to preparation of the nonmagnetic layer-forming coating material, the magnetic layer-forming coating material, and the back coat layer-forming coating material.

Examples of the solvent used for preparing the above coating materials include a ketone-based solvent such as acetone, methyl ethyl ketone, methyl isobutyl ketone, or cyclohexanone, an alcohol-based solvent such as methanol, ethanol, or propanol, an ester-based solvent such as methyl acetate, ethyl acetate, butyl acetate, propyl acetate, ethyl lactate, or ethylene glycol acetate, an ether-based solvent such as diethylene glycol dimethyl ether, 2-ethoxyethanol, tetrahydrofuran, or dioxane, an aromatic hydrocarbon-based solvent such as benzene, toluene, or xylene, a halogenated hydrocarbon-based solvent such as methylene chloride, ethylene chloride, carbon tetrachloride, chloroform, or chlorobenzene, and the like. These solvents may be used singly or in mixture of two or more kinds thereof.

Examples of the kneading apparatus used for preparing the above coating materials include a kneading apparatus such as a continuous twin-screw kneading machine, a continuous twin-screw kneading machine capable of performing dilution in multiple stages, a kneader, a pressure kneader, or a roll kneader, but are not particularly limited to these apparatuses. In addition, examples of the dispersing apparatus used for preparing the above coating materials include a dispersing apparatus such as a roll mill, a ball mill, a horizontal sand mill, a vertical sand mill, a spike mill, a pin mill, a tower mill, a pearl mill (for example, a “DCP mill” manufactured by Eirich Co., Ltd. and the like), a homogenizer, or an ultrasonic wave dispersing machine, but are not particularly limited to these apparatuses.

### Step of Forming Nonmagnetic Layer

Subsequently, a nonmagnetic layer-forming coating material is applied onto one main surface of the substrate 11 and dried to form the nonmagnetic layer 12 on the one main surface of the substrate 11.

### Step of Forming Magnetic Layer

Subsequently, a magnetic layer-forming coating material is applied onto the nonmagnetic layer 12 and dried to form the magnetic layer 13 on the nonmagnetic layer 12. Note that the cubic ferrite magnetic powder is oriented in a magnetic field in a thickness direction or a longitudinal direction of the elongated substrate 11 during drying.

### Step of Forming Back Coat Layer

Subsequently, a back coat layer-forming coating material is applied onto the other main surface of the substrate 11 and dried, if necessary, to form the back coat layer 14 on the other main surface of the substrate 11. The wide magnetic recording medium 10 is thereby obtained.

### Step of Calendering Treatment and Cutting

Subsequently, the obtained wide magnetic recording medium 10 is rewound around a large-diameter core and cured. Subsequently, the wide magnetic recording medium 10 is calendered and then cut into a predetermined width. The intended magnetic recording medium 10 is thereby obtained. Note that the step of forming the back coat layer 14 may be performed after the calendering treatment.

### 3.3 Effect

In the third embodiment of the present technology, the magnetic layer 13 contains the magnetic powder according to the first embodiment, and therefore a high density magnetic recording medium having favorable magnetic characteristics can be provided.

### 3.4 Modification Example

In place of the magnetic powder (cubic ferrite magnetic powder) according to the first embodiment, the magnetic powder (hexagonal ferrite magnetic powder) according to the second embodiment may be used. In this case, the magnetic powder (hexagonal ferrite magnetic powder) is oriented in a thickness direction of the substrate 11.

In the magnetic recording medium according to the third embodiment, a configuration in which the nonmagnetic layer is omitted may be adopted.

### EXAMPLES

Hereinafter, the present technology will be described specifically with Examples, but the present technology is not limited only to these Examples.

### Example 1

First, a cobalt ferrite magnetic powder (cubic ferrite magnetic powder) having a coercive force Hc of 1000 Oe was prepared. Subsequently, the prepared magnetic powder was irradiated with 20 kGy of a γ ray (electromagnetic radiation) emitted from a Co60 γ ray source. At this time, the temperature was adjusted with cooling water such that the temperature of the magnetic powder was 100° C. or lower. As a result, a magnetic powder for a magnetic tape was obtained.

### Example 2

A magnetic powder for a magnetic tape was obtained in a similar manner to Example 1 except that a cobalt ferrite magnetic powder was irradiated with 20 kGy of an α-ray (particle radiation) in place of a γ ray (electromagnetic radiation).

### Example 3

First, a barium ferrite magnetic powder (hexagonal ferrite magnetic powder) having a coercive force Hc of 4500 Oe was prepared. Subsequently, the prepared magnetic powder was irradiated with 10 kGy of a γ ray (electromagnetic radiation) emitted from a Co60 γ ray source. At this time, the temperature was adjusted with cooling water such that the temperature of the magnetic powder was 100° C. or lower. As a result, a magnetic powder for a magnetic tape was obtained.

### Example 4

A magnetic powder for a magnetic tape was obtained in a similar manner to Example 3 except that a barium ferrite magnetic powder was irradiated with 20 kGy of an α-ray (particle radiation) in place of a γ ray (electromagnetic radiation).

### TEM Observation

The magnetic powders for a magnetic tape of Examples 1 to 4 obtained as described above were observed by a TEM. As a result, it was observed that lattice defects had been introduced into a crystal lattice of each of the magnetic powders.

### Coercive Force Hc

A coercive force Hc of each of the magnetic powders for a magnetic tape of Examples 1 to 4 obtained as described above was measured using a VSM manufactured by Lake Shore Cryotronics, Inc. under the conditions of an ambient temperature of 23° C. and an applied magnetic field of 15 kOe. Note that the coercive force Hc before irradiation with a radiation was also measured in a similar manner to this measurement.

From a measurement result of the coercive force Hc before and after irradiation with a radiation, the following was confirmed. That is, it was confirmed that the coercive force Hc increased with irradiation with a γ ray and an α ray in the cobalt ferrite magnetic powder. Meanwhile, it was confirmed that the coercive force Hc decreased by irradiation with a γ ray and an α ray in the barium ferrite magnetic powder.

### SFD

The amount of magnetization with respect to a magnetic field was measured with a similar apparatus under similar measurement conditions to those in the measurement of the coercive force Hc, and a half value width ΔH of a differential curve thereof was normalized by the coercive force Hc to obtain an SFD.

From the above measurement results of an SFD, the following was confirmed. That is, it was confirmed that the cobalt ferrite magnetic powder had an SFD of 1 or less after irradiation with a γ ray and an α ray. Meanwhile, it was confirmed that even the barium ferrite magnetic powder had an SFD of 1 or less after irradiation with a γ ray and an α ray.

### Examples 5 to 8

### Step of Preparing Magnetic Layer-Forming Coating Material

A magnetic layer-forming coating material was prepared as follows. First, the following raw materials were kneaded with an extruder to obtain a kneaded product.

Magnetic powder: 100 parts by mass

(However, in Examples 5 to 8, magnetic powders for a magnetic tape of Examples 1 to 4 were used, respectively.)

Vinyl chloride-based resin (cyclohexanone solution 30% by mass): 55.6 parts by mass

(Degree of polymerization: 300, Mn=10000, OSO3K=0.07 mmol/g and secondary OH=0.3 mmol/g were contained as polar groups)

Aluminum oxide powder: 5 parts by mass

(α-Al₂O₃, average particle diameter: 0.2 μm)

Carbon black: 2 parts by mass

(Manufactured by Tokai Carbon Co., Ltd., trade name: Seast TA)

Subsequently, the kneaded product and the following raw materials were put in a stirring tank equipped with a disper and premixed. Thereafter, the mixture was further subjected to sand mill mixing and a filter treatment to prepare a magnetic layer-forming coating material.

Vinyl chloride-based resin: 27.8 parts by mass

(Resin solution: resin content 30% by mass, cyclohexanone 70% by mass)

Polyisocyanate: 4 parts by mass

(Trade name: Coronate L, manufactured by Nippon Polyurethane Industry Co., Ltd.)

Myristic acid: 2 parts by mass

N-Butyl stearate: 2 parts by mass

Methyl ethyl ketone: 121.3 parts by mass

Toluene: 121.3 parts by mass

Cyclohexanone: 60.7 parts by mass

### Step of Preparing Nonmagnetic Layer-Forming Coating Material

A nonmagnetic layer-forming coating material was prepared as follows. First, the following raw materials were kneaded with an extruder to obtain a kneaded product.

Acicular iron oxide powder: 100 parts by mass

(α-Fe₂O₃, average long axis length 0.15 μm)

Vinyl chloride-based resin: 55.6 parts by mass

(Resin solution: resin content 30% by mass, cyclohexanone 70% by mass)

Carbon black: 10 parts by mass

(Average particle diameter 20 nm)

Subsequently, the kneaded product and the following raw materials were put in a stirring tank equipped with a disper and premixed. Thereafter, the mixture was further subjected to sand mill mixing and a filter treatment to prepare a nonmagnetic layer-forming coating material.

Polyurethane-based resin UR8200 (manufactured by Toyobo Co., Ltd.): 18.5 parts by mass

Polyisocyanate: 4 parts by mass

(Trade name: Coronate L, manufactured by Nippon Polyurethane Industry Co., Ltd.)

Myristic acid: 2 parts by mass

N-Butyl stearate: 2 parts by mass

Methyl ethyl ketone: 108.2 parts by mass

Toluene: 108.2 parts by mass

Cyclohexanone: 18.5 parts by mass

### Step of Preparing Back Coat Layer-Forming Coating Material

A back coat layer-forming coating material was prepared as follows. The following raw materials were mixed in a stirring tank equipped with a disper and subjected to a filter treatment to prepare a back coat layer-forming coating material.

Carbon black (manufactured by Asahi Corporation, trade name: # 80): 100 parts by mass

Polyester polyurethane: 100 parts by mass

(Trade name: N-2304, manufactured by Nippon Polyurethane Industry Co., Ltd.)

Methyl ethyl ketone: 500 parts by mass

Toluene: 400 parts by mass

Cyclohexanone: 100 parts by mass

### Step of Forming Nonmagnetic Layer and Magnetic Layer

Subsequently, a nonmagnetic layer (underlayer) and a magnetic layer (recording layer) were formed as follows. First, a nonmagnetic layer-forming coating material was applied onto one main surface of a strip-shaped PEN film having a thickness of 6.2 μm as a nonmagnetic support and dried to form a nonmagnetic layer having an average thickness of 1 μm on the one main surface of the PEN film. Subsequently, a magnetic layer-forming coating material was applied onto the nonmagnetic layer and dried to form a magnetic layer having an average thickness of 70 nm on the nonmagnetic layer. Note that the magnetic powder was oriented in a thickness direction of the PEN film during drying.

### Step of Forming Back Coat Layer

Subsequently, a back coat layer-forming coating material was applied onto the other main surface of the PEN film and dried to form a back coat layer having an average thickness of 0.6 μm on the other main surface of the PEN film. As a result, a wide magnetic tape was obtained.

### Step of Calendering Treatment and Cutting

Subsequently, the obtained wide magnetic tape was calendered with a metal roll to smoothen a surface of the magnetic layer. Subsequently, the wide magnetic tape was cut into a width of ½ inch (12.65 mm) to obtain an intended magnetic tape.

### Signal Characteristics

The magnetic tapes of Examples 5 to 8 obtained as described above were caused to travel with a commercially available tape traveling type system manufactured by Mountain Engineering, Inc., and recording and reproduction were performed using a head for a linear tape drive to obtain a signal-noise ratio (SNR). As a result, a favorable SNR was obtained in any one of the magnetic tapes of Examples 5 to 8.

Hereinabove, the embodiments and Examples of the present technology have been described specifically. However, the present technology is not limited to the above embodiments, but various modifications based on a technical idea of the present technology can be made.

For example, the configurations, the methods, the steps, the shapes, the materials, the numerical values, and the like exemplified in the above embodiments, Modification Examples thereof, and Examples are only examples, and a configuration, a method, a step, a shape, a material, a numerical value, and the like different therefrom may be used, if necessary.

In addition, the configurations, the methods, the steps, the shapes, the materials, the numerical values, and the like in the above embodiments, Modification Examples thereof, and Examples can be combined to each other as long as not departing from the gist of the present technology.

In addition, the present technology can adopt the following configurations.

(1)

A method for manufacturing a magnetic powder, including changing a coercive force of a magnetic powder by irradiation with a radiation.

(2)

The method for manufacturing a magnetic powder according to (1), in which the change in coercive force is an increase in coercive force.

(3)

The method for manufacturing a magnetic powder according to (2), in which the magnetic powder is a cubic ferrite magnetic powder.

(4)

The method for manufacturing a magnetic powder according to (2), in which the magnetic powder is a cobalt ferrite magnetic powder.

(5)

The method for manufacturing a magnetic powder according to (1), in which the change in coercive force is a decrease in coercive force.

(6)

The method for manufacturing a magnetic powder according to (5), in which the magnetic powder is a hexagonal ferrite magnetic powder.

(7)

The method for manufacturing a magnetic powder according to (5), in which the magnetic powder is a barium ferrite magnetic powder.

(8)

The method for manufacturing a magnetic powder according to any one of (1) to (7), in which lattice defects are introduced into the magnetic powder by irradiation with the radiation.

(9)

The method for manufacturing a magnetic powder according to any one of (1) to (8), in which the radiation is an ionizing radiation.

(10)

The method for manufacturing a magnetic powder according to any one of (1) to (9), in which the radiation is an electromagnetic radiation.

(11)

The method for manufacturing a magnetic powder according to any one of (1) to (9), in which the radiation is a particle radiation.

(12)

The method for manufacturing a magnetic powder according to any one of (1) to (9), in which the radiation is one or more selected from the group consisting of a gamma ray, a beta ray, and an alpha ray.

(13)

The method for manufacturing a magnetic powder according to any one of (1) to (12), in which

the magnetic powder is a magnetic powder for a magnetic recording medium, and

irradiation with the radiation is adjusted such that the magnetic powder has a coercive force of 2500 Oe or more and 4000 Oe or less and has a switching field distribution of 1 or less.

(14)

A method for manufacturing a magnetic recording medium, including:

changing a coercive force of a magnetic powder by irradiation with a radiation; and

forming a magnetic layer containing the magnetic powder having the coercive force changed.

(15)

A magnetic powder having lattice defects, including magnetic particles containing cubic ferrite, having a coercive force of 2500 Oe or more and 4000 Oe or less, and having a switching field distribution of 1 or less.

(16)

The magnetic powder according to (15), in which the coercive force is 2500 Oe or more and 3500 Oe or less.

(17)

The magnetic powder according to (15) or (16), in which the cubic ferrite is cobalt ferrite.

(18)

The magnetic powder according to any one of (15) to (17), in which the cobalt ferrite contains Co and one or more selected from the group consisting of Ni, Mn, Al, Cu, and Zn.

(19)

A magnetic recording medium including:

a substrate; and

a magnetic layer containing a magnetic powder, in which

the magnetic powder has lattice defects and includes magnetic particles containing cubic ferrite, and

the magnetic powder has a coercive force of 2500 Oe or more and 4000 Oe or less and has a switching field distribution of 1 or less.

(20)

The magnetic recording medium according to (19), further including a nonmagnetic layer disposed between the substrate and the magnetic layer.

### REFERENCE SIGNS LIST

10 Magnetic recording medium

11 Substrate

12 Nonmagnetic layer

13 Magnetic layer

14 Back coat layer

1. A method for manufacturing a magnetic powder, comprising changing a coercive force of a magnetic powder by irradiation with a radiation.

2. The method for manufacturing a magnetic powder according to claim 1, wherein the change in coercive force is an increase in coercive force.

3. The method for manufacturing a magnetic powder according to claim 2, wherein the magnetic powder is a cubic ferrite magnetic powder.

4. The method for manufacturing a magnetic powder according to claim 2, wherein the magnetic powder is a cobalt ferrite magnetic powder.

5. The method for manufacturing a magnetic powder according to claim 1, wherein the change in coercive force is a decrease in coercive force.

6. The method for manufacturing a magnetic powder according to claim 5, wherein the magnetic powder is a hexagonal ferrite magnetic powder.

7. The method for manufacturing a magnetic powder according to claim 5, wherein the magnetic powder is a barium ferrite magnetic powder.

8. The method for manufacturing a magnetic powder according to claim 1, wherein lattice defects are introduced into the magnetic powder by irradiation with the radiation.

9. The method for manufacturing a magnetic powder according to claim 1, wherein the radiation is an ionizing radiation.

10. The method for manufacturing a magnetic powder according to claim 1, wherein the radiation is an electromagnetic radiation.

11. The method for manufacturing a magnetic powder according to claim 1, wherein the radiation is a particle radiation.

12. The method for manufacturing a magnetic powder according to claim 1, wherein the radiation is one or more selected from the group consisting of a gamma ray, an alpha ray, and a beta ray.

13. The method for manufacturing a magnetic powder according to claim 1, wherein
the magnetic powder is a magnetic powder for a magnetic recording medium, and
irradiation with the radiation is adjusted such that the magnetic powder has a coercive force of 2500 Oe or more and 4000 Oe or less and has a switching field distribution of 1 or less.

14. A method for manufacturing a magnetic recording medium, comprising:
changing a coercive force of a magnetic powder by irradiation with a radiation; and
forming a magnetic layer containing the magnetic powder having the coercive force changed.

15. A magnetic powder having lattice defects, comprising magnetic particles containing cubic ferrite, having a coercive force of 2500 Oe or more and 4000 Oe or less, and having a switching field distribution of 1 or less.

16. The magnetic powder according to claim 15, wherein the coercive force is 2500 Oe or more and 3500 Oe or less.

17. The magnetic powder according to claim 15, wherein the cubic ferrite is cobalt ferrite.

18. The magnetic powder according to claim 17, wherein the cobalt ferrite contains Co and one or more selected from the group consisting of Ni, Mn, Al, Cu, and Zn.

19. A magnetic recording medium comprising:
a substrate; and
a magnetic layer containing a magnetic powder, wherein
the magnetic powder has lattice defects and includes magnetic particles containing cubic ferrite, and
the magnetic powder has a coercive force of 2500 Oe or more and 4000 Oe or less and has a switching field distribution of 1 or less.

20. The magnetic recording medium according to claim 19, further comprising a nonmagnetic layer disposed between the substrate and the magnetic layer.
